(19) United States
(12) Patent Application Publication
(10) Pub. No.: US 2026/0279822 A1
(43) Pub. Date: Sep. 17, 2026

(54) Long Carbon Fibers for Boosting Performance of Dry Processed Li-Ion Battery Electrodes

(71) Applicant: UT-Battelle, LLC, Oak Ridge, TN (US)

(72) Inventors: Jaswinder K. Sharma, Farragut, TN (US); Junbin Choi, Knoxville, TN (US); Georgios Polyzos, Knoxville, TN (US)

(21) Appl. No.: 19/563,299

(22) Filed: Mar. 11, 2026

Related U.S. Application Data
(60) Provisional application No. 63/770,541, filed on Mar. 12, 2025.

(51) Int. Cl. H01M 4/62; H01M 4/02; H01M 4/04

(52) U.S. Cl. CPC H01M 4/625; H01M 4/622; H01M 2004/021; H01M 4/0435

(57) ABSTRACT

A method of manufacturing a dry-processed battery electrode is provided. The method includes providing a mixture comprising an electrode active material, a conductive carbon material, a polymer binder, and carbon fibers having an average length of at least 5 mm prior to dry mixing. The mixture is dry mixed under shear conditions and compressed to form an electrode sheet. The electrode sheet may be used as a free-standing electrode or affixed to a metallic current collector. A dry-processed battery electrode is also provided. The dry-processed battery electrode comprises the electrode active material, the conductive carbon material, the fibrillated polymer binder, and carbon fibers dispersed throughout the electrode with an average length of about 20 μm to about 150 μm. The electrode sheet may be used as a free-standing electrode or affixed to a metallic current collector.

### CROSS-REFERENCE TO RELATED APPLICATIONS

This application claims the benefit of U.S. Provisional Application 63/770,541, filed Mar. 12, 2025, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present disclosure relates to solvent-free methods and materials for fabricating battery electrodes, and more particularly to dry-processed electrode sheets reinforced with carbon fibers.

### BACKGROUND OF THE INVENTION

Due to rapid development of electric vehicles and electronic devices, the demand for lithium-ion batteries continues to grow. As battery production volumes increase, there is significant pressure to reduce manufacturing costs, improve production efficiency, and minimize environmental impact. Electrode fabrication represents a substantial portion of lithium-ion battery manufacturing cost and energy consumption. As such, there are strong economic and environmental incentives to develop improved electrode manufacturing processes that reduce solvent usage, decrease energy requirements, and simplify production.

Conventional lithium-ion battery electrode fabrication methods typically employ solvent-based slurry casting processes. In such methods, active materials, conductive additives, and polymer binders are dispersed in an organic solvent, such as N-methyl-2-pyrrolidone (NMP), to form a slurry. The slurry is coated onto a metallic current collector and subsequently subjected to a drying step to remove the solvent. The drying and solvent recovery processes require substantial energy input and specialized equipment, thereby increasing capital costs and limiting throughput. In addition, solvent handling introduces environmental and regulatory concerns.

Solvent-free dry processing methods have been developed to address these concerns. In certain dry processes, powder mixtures comprising active material, conductive carbon, and polymer binder are mechanically mixed under shear conditions and subsequently compressed to form electrode films. By eliminating liquid solvents and drying steps, dry processing offers potential reductions in energy consumption, environmental impact, and manufacturing complexity. However, dry-processed electrode films may suffer from insufficient mechanical integrity, particularly when fabricated as thin films or when formed without direct support from a metallic current collector. Such films may be prone to cracking, delamination, or handling difficulties. Additionally, electronic conductivity and thermal transport within dry-processed electrodes may be limited by the distribution and connectivity of conductive additives.

As such, while dry electrode processing remains a promising approach to reduce manufacturing costs and environmental burden, there remains a need to improve dry-processed lithium-ion battery electrodes to enhance mechanical robustness, electrical conductivity, and electrochemical performance. In particular, there is a need for solvent-free electrode fabrication methods capable of producing electrode sheets that maintain structural integrity during handling and exhibit improved conductive networks within the electrode structure.

### SUMMARY OF THE INVENTION

A method of manufacturing a dry-processed battery electrode is provided. The method includes providing a mixture comprising an electrode active material, a conductive carbon material, a polymer binder, and carbon fibers. The method further includes dry mixing the mixture in the absence of solvent and under shear conditions to form a dry mixture, and compressing the dry mixture to form a free-standing electrode sheet. The carbon fibers have an average length of at least about 5 mm prior to the dry mixing.

In certain embodiments, the carbon fibers have an average length of at least about 5 mm prior to dry mixing, alternatively about 5 mm to about 10 mm prior to dry mixing. The carbon fibers may have an average diameter of about 3 μm to about 10 μm, alternatively about 5 μm. The carbon fibers may be present in an amount of about 0.25 wt. % to about 2 wt. % based on the total weight of the dry mixture, alternatively about 1 wt. %.

In some embodiments, the dry mixture comprises about 85 wt. % to about 95 wt. % of the electrode active material, about 1 wt. % to about 7 wt. % of the polymer binder, about 2 wt. % to about 6 wt. % of the conductive carbon material, and about 0.25 wt. % to about 2 wt. % of the carbon fibers, each based on the total weight of the dry mixture. In certain embodiments, the dry mixture comprises about 90 wt. % electrode active material, about 5 wt. % polymer binder, about 4 wt. % conductive carbon material, and about 1 wt. % carbon fibers.

The electrode active material may comprise one or more of lithium nickel manganese cobalt oxide (NMC), lithium nickel cobalt aluminum oxide (NCA), lithium iron phosphate (LFP), lithium manganese oxide (LMO), and lithium cobalt oxide (LCO). The conductive carbon material may comprise one or more of carbon black, carbon nanotubes, graphene, graphite, and vapor-grown carbon fibers. The polymer binder may comprise one or more of polytetrafluoroethylene (PTFE), polyvinylidene fluoride (PVDF), polyethylene oxide (PEO), and styrene-butadiene rubber (SBR).

In some embodiments, the carbon fibers are fragmented during the dry mixing to an average length of about 50 μm to about 1 mm in the dry-processed battery electrode, alternatively about 100 μm. In certain embodiments, the dry mixing causes fibrillation of the polymer binder to form a fibrous binder network that binds the electrode active material, conductive carbon material, and carbon fibers into a cohesive structure.

In certain embodiments, forming the free-standing electrode sheet comprises roll pressing the dry mixture using a heated roller. The step of affixing the free-standing electrode sheet to the metallic current collector may comprise calendaring the free-standing electrode sheet to the metallic current collector.

In some embodiments, the free-standing electrode sheet may be used as a mechanically self-supporting electrode without lamination to a metallic current collector.

A dry-processed battery electrode is also provided. The dry-processed battery electrode comprises an electrode active material, a conductive carbon material, a fibrillated polymer binder, and carbon fibers dispersed throughout the electrode. The carbon fibers have an average length of about 20 μm to about 150 μm within the electrode. In certain embodiments, the carbon fibers have an average length of at least about 100 μm.

In some embodiments, the dry-processed battery electrode is a mechanically self-supporting film not affixed to a metallic current collector. In other embodiments, the dry-processed battery electrode further comprises a metallic current collector affixed to the electrode.

### BRIEF DESCRIPTION OF THE DRAWINGS

FIG. 1 illustrates a schematic of the dry processing method and resulting microstructure of the powder after the dry mixing process.

FIGS. 2a-2e illustrate representative images of long carbon fibers prior to dry mixing and of the dry-mixed powder and consolidated electrode sheet. FIG. 2a shows an optical image of carbon fibers prior to mixing. FIG. 2b shows a scanning electron microscopy (SEM) image of the carbon fibers prior to mixing. FIG. 2c shows the dry-mixed powder comprising electrode active material, polymer binder, conductive carbon material, and carbon fibers after shear mixing. FIG. 2d shows an SEM image of the dry-mixed powder illustrating fibrillation of the binder and fragmentation of the carbon fibers. FIG. 2e shows a dry-processed electrode sheet after roll pressing and calendaring, including a punched electrode disc.

FIGS. 3a-3d show representative top-view and cross-sectional SEM images of dry-processed electrode films without carbon fibers (DP-Base) and with carbon fibers (DP-CF). FIGS. 3a and 3b correspond to the DP-Base electrode, and FIGS. 3c and 3d correspond to the DP-CF electrode. Arrows indicate carbon fiber segments within the electrode.

FIG. 4 shows measured thermal conductivity, electronic conductivity, and tensile strength values for DP-Base and DP-CF electrodes.

FIG. 5 shows Nyquist plots obtained from electrochemical impedance spectroscopy (EIS) for DP-Base and DP-CF electrodes.

FIGS. 6a-6c show representative voltage profiles and cycling performance for DP-Base, DP-CF, and standalone DP-CF electrodes.

FIGS. 7a-7b show long-term cycle life and rate capability performance for DP-Base, DP-CF, and DP-CF Standalone electrodes. FIG. 7a shows long-term cycle life test results. FIG. 7b shows rate capability test results for the DP-Base, DP-CF, and DP-CF Standalone electrodes.

FIG. 8 shows differential scanning calorimetry (DSC) curves for DP-Base and DP-CF electrodes.

FIG. 9 illustrates a dry-processed electrode material affixed to a metallic current collector in accordance with a further embodiment.

### DETAILED DESCRIPTION OF THE CURRENT EMBODIMENTS

A method of manufacturing a dry-processed battery electrode is provided. As described herein, the method enables solvent-free fabrication of lithium-ion battery electrodes, thereby reducing energy consumption, eliminating organic solvent handling, and simplifying manufacturing infrastructure relative to conventional slurry-casting processes. The method incorporates long carbon fibers into a dry electrode formulation to enhance mechanical robustness, electrical conductivity, and thermal conductivity. The resulting electrode sheets may be mechanically self-supporting (free-standing) and may optionally be affixed to metallic current collectors for use in lithium-ion batteries. Also providing herein is a dry-processed battery electrode having enhanced mechanical, thermal, and electrical properties.

As understood by those of skill in the art, a principal challenge in solvent-free dry electrode processing is achieving sufficient mechanical integrity and through-thickness electronic connectivity in the absence of solvent-assisted binder distribution. Conventional dry-processed electrodes relying solely on particulate conductive additives may exhibit limited crack resistance, reduced tensile strength, and incomplete conductive percolation across the electrode thickness, particularly at elevated areal loadings or when fabricated as unsupported films. Increasing conductive additive content to compensate for poor percolation typically reduces active material loading and energy density. The present disclosure addresses these limitations by incorporating millimeter-scale carbon fibers into the dry mixture prior to shear mixing. During dry processing, the fibers are fragmented and distributed to form an internal reinforcement and conductive network extending throughout the electrode structure, thereby enhancing mechanical robustness and electronic transport without substantially reducing active material loading.

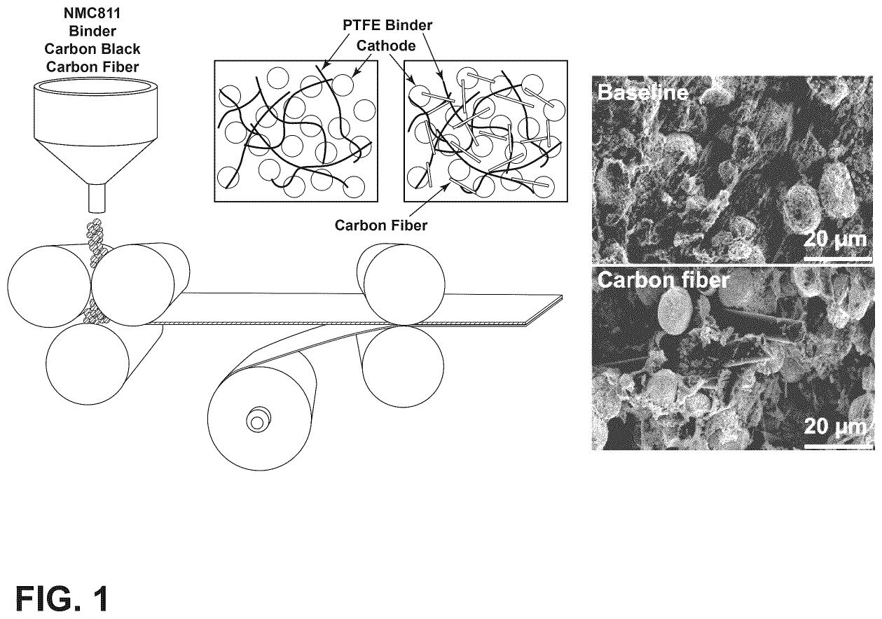

The method according to one embodiment of the invention is generally depicted diagrammatically in FIG. 1. In general, the method comprises providing a dry mixture including an electrode active material, a conductive carbon material, a polymer binder, and long carbon fibers; dry mixing the components under shear conditions in the absence of solvent; and compressing the dry mixture to form a free-standing electrode sheet. In certain embodiments, the method further includes affixing the free-standing electrode sheet to a metallic current collector.

More particularly, the method includes providing a mixture comprising an electrode active material, a conductive carbon material, a polymer binder, and carbon fibers; dry mixing the mixture in the absence of solvent and under shear conditions to form a cohesive dry mixture; and compressing the dry mixture to form a free-standing electrode sheet. In certain embodiments, the carbon fibers have an average length of at least about 5 mm prior to the dry mixing. During the dry mixing step, the carbon fibers may be mechanically fragmented and dispersed throughout the electrode to form an internal reinforcement network. In certain embodiments, the dry mixing causes fibrillation of the polymer binder to form a fibrous binder network that binds the electrode active material, conductive carbon material, and carbon fibers into a consolidated electrode structure. The resulting dry-processed battery electrode comprises the electrode active material, the conductive carbon material, the fibrillated polymer binder, and carbon fibers dispersed throughout the electrode. The details of these steps and components of the method are described in detail below.

As will be appreciated in view of the description herein, the scope of the dry-processed battery electrodes and manufacturing methods described herein is not particularly limited to the particular embodiments exemplified. In particular, the electrode active material, conductive carbon material, polymer binder, carbon fibers, mixing equipment, and consolidation equipment may be selected by one of ordinary skill in the art in view of the intended battery chemistry, electrode loading, and manufacturing configuration. The dry-processed electrode structures described herein may be incorporated into lithium-ion batteries, sodium-ion batteries, lithium-metal batteries, solid-state batteries, hybrid capacitors, or other electrochemical energy storage systems employing composite electrodes. Likewise, the electrodes may be configured as cathodes, anodes, or other electrochemically active components depending on system design.

The method includes providing a mixture comprising an electrode active material, a conductive carbon material, a polymer binder, and carbon fibers. The mixture is provided in a substantially dry form and is prepared in the absence of liquid solvent. Each component may be provided as a particulate solid, powder, fiber, or combination thereof.

As used herein, “substantially dry” and “in the absence of liquid solvent” mean that no liquid is present in an amount sufficient to dissolve or suspend the polymer binder or otherwise form a flowable coating slurry. Trace amounts of residual solvents, atmospheric moisture, sizing agents on fibers, or solvent carried on particulate materials (e.g., <1 wt. % based on total batch mass) do not render the process a solvent-based slurry coating process and are expressly contemplated. In certain embodiments, the dry mixing is carried out in the absence of intentionally added organic solvents (for example, N-methyl-2-pyrrolidone, dimethylformamide, or water) in amounts sufficient to dissolve the binder.

### Electrode Active Material

The mixture includes an electrode active material. The electrode active material is not particularly limited and may comprise any material suitable for use in lithium-ion battery electrodes. In certain embodiments, the electrode active material comprises one or more lithium-containing compounds selected from lithium nickel manganese cobalt oxide (NMC), lithium nickel cobalt aluminum oxide (NCA), lithium iron phosphate (LFP), lithium manganese oxide (LMO), lithium cobalt oxide (LCO), or combinations thereof.

In certain embodiments, the electrode active material is further defined as a cathode active material. The cathode active material may comprise a lithium-bearing metal oxide suitable for use in lithium-ion battery electrodes. Examples of such compounds include LiCoO₂, LiMn₂O₄, LiNiO₂, LiCrO₂, LiFePO₄, LiV₂O₅, LiTiS₂, LiMoS₂, LiMnO₂, LiFe₁−zM_{y}PO₄, as well as variations of lithium nickel oxides, lithium nickel manganese oxides, lithium nickel manganese cobalt oxides, lithium nickel cobalt aluminum oxides, and related materials. Representative compositions include layered lithium transition metal oxides having general formulas such as LiNixMnyO₂, Li₁+zNixMnyCo₁−x−yO₂, LiNixCoyAlzO₂, and LiNixCoyMnzO₂, where x, y, and z are mole fractions ranging from 0 to 1 and x+y+z=1. Such materials are well known in the art and may be selected according to desired electrochemical performance characteristics. In particular embodiments, the electrode active material comprises LiNi_{0·8}Mn_{0·1}Co_{0·1}O₂(NMC811). The electrode active material may further comprise conductive agents or surface treatments to enhance electronic conductivity and stability.

In some embodiments, the electrode active material is further defined as an anode active material. The anode active material may comprise a lithium-intercalating or lithium-alloying material suitable for use in lithium-ion battery electrodes. Examples of such materials include graphite (natural or synthetic), hard carbon, soft carbon, lithium titanate (Li₄Ti₅O₁₂), silicon, silicon oxide (SiOx), silicon-carbon composites, tin-based materials, germanium-based materials, and related alloying materials. Representative compositions include carbonaceous materials having graphitic or amorphous structures, lithium titanate spinel structures, and silicon-containing composite materials configured for reversible lithium insertion and extraction. Such materials are well known in the art and may be selected according to desired electrochemical performance characteristics, including capacity, rate capability, and cycling stability. In particular embodiments, the electrode active material comprises graphite. The electrode active material may further comprise conductive agents or surface treatments to enhance electronic conductivity and stability.

In certain embodiments, the electrode active material is present in an amount of about 80 wt. % to about 97 wt. % based on total weight of the dry mixture, alternatively about 85 wt. % to about 95 wt. %, and in particular embodiments about 88 wt. % to about 92 wt. % or about 90 wt. %. The amount of electrode active material may be selected to maximize energy density while maintaining sufficient binder and conductive components to provide mechanical integrity and electronic percolation within the dry-processed electrode.

### Conductive Carbon Material

The mixture includes a conductive carbon material. The conductive carbon material is not particularly limited and may comprise any electrically conductive material suitable for use in lithium-ion battery electrodes. The conductive carbon material is distinct from the long carbon fibers and generally comprises particulate or nanoscale carbonaceous materials configured primarily to enhance electronic conductivity within the electrode matrix. Without being bound by any particular theory, the conductive carbon material is believed to facilitate formation of an electronically percolating network between adjacent particles of electrode active material, thereby reducing electronic resistance within the dry-processed electrode.

In certain embodiments, the conductive carbon material comprises one or more electrically conductive carbonaceous materials selected from carbon black (for example, acetylene black, furnace black, Ketjenblack, or Super P), carbon nanotubes (single-walled or multi-walled), carbon nanofibers (CNF), graphene, graphene nanoplatelets, reduced graphene oxide, graphite powders, vapor-grown carbon fibers (VGCF), or combinations thereof.

In some embodiments, the conductive carbon material comprises particulate materials having an average particle size of less than about 50 μm, alternatively less than about 10 μm, and in certain embodiments nanoscale materials such as carbon nanotubes or graphene having characteristic dimensions of less than about 1 μm and in certain other embodiments nanoscale materials such as carbon black having characteristic dimensions of less than about 100 nm. Such particulate or nanoscale conductive additives are distinguishable from the long carbon fibers described herein, which have an initial average length of at least about 5 mm prior to dry mixing.

In certain embodiments, the conductive carbon material comprises carbon black. In other embodiments, the conductive carbon material comprises a combination of carbon black and carbon nanotubes. In some embodiments, the carbon conductive material may further comprise graphene or graphite.

In certain embodiments, the conductive carbon material is present in an amount of about 1 wt. % to about 10 wt. % based on total weight of the dry mixture, alternatively about 2 wt. % to about 6 wt. %, and in particular embodiments about 3 wt. % to about 5 wt. % or about 4 wt. %. The conductive carbon content may be selected to achieve electronic percolation throughout the electrode while maintaining high active material loading and mechanical cohesion of the consolidated dry-processed electrode sheet.

### Polymer Binder

The mixture includes a polymer binder. The polymer binder is not particularly limited and may comprise any polymer binder suitable for use in dry processing of lithium-ion battery electrodes. The polymer binder is configured to bind together the electrode active material, the conductive carbon material, and the carbon fibers to form a cohesive structure during dry processing. The polymer binder is selected to provide sufficient mechanical cohesion, particle adhesion, and structural integrity upon application of shear and compressive forces. In certain embodiments, the polymer binder is capable of forming a continuous matrix within the electrode during dry mixing and subsequent compression.

In certain embodiments, the polymer binder comprises a fibrillatable binder capable of forming a fibrous network under shear conditions during the dry mixing step. Fibrillation refers to elongation and mechanical deformation of the polymer binder under shear to form interconnected fibrous strands that entangle and interlock electrode components. In particular embodiments, the polymer binder comprises polytetrafluoroethylene (PTFE). During dry mixing, the PTFE undergoes shear-induced fibrillation, resulting in formation of a fibrous binder network that mechanically interconnects the electrode active material, conductive carbon material, and carbon fibers into a consolidated electrode structure.

In some embodiments, the fibrillated binder network cooperates with the fragmented carbon fibers to create an interconnected reinforcement framework throughout the electrode thickness. Without intending to be bound by theory, it is believed that the fibrous PTFE strands mechanically entangle with the elongated carbon fibers, thereby improving load transfer, crack resistance, and structural cohesion of the free-standing electrode sheet.

In certain embodiments, the polymer binder may comprise one or more of polyvinylidene fluoride (PVDF), polyethylene oxide (PEO), styrene-butadiene rubber (SBR), carboxymethyl cellulose (CMC), polyacrylic acid (PAA), fluorinated ethylene-propylene copolymers (FEP), perfluoroalkoxy polymers (PFA), polyimides, or combinations thereof. The polymer binder may be provided as a homopolymer, copolymer, interpolymer, or multipolymer composition. In certain embodiments, the polymer binder may be substantially free from PVDF.

In certain embodiments, the polymer binder exhibits a melting temperature, glass transition temperature, or softening point compatible with the temperatures employed during roll pressing or calendaring. The polymer binder may soften under compression to promote consolidation while retaining sufficient mechanical strength upon cooling to maintain electrode integrity.

In some embodiments, the polymer binder is present in an amount of about 1 wt. % to about 10 wt. % based on total weight of the mixture, alternatively about 3 wt. % to about 7 wt. %, and in particular embodiments about 5 wt. %. The binder content may be selected to balance mechanical integrity and electronic conductivity while maintaining high active material loading.

### Carbon Fibers

The mixture includes carbon fibers incorporated as reinforcement elements within the dry-processed electrode. The carbon fibers are structurally distinct from the conductive carbon material and are configured to provide mechanical reinforcement and extended conductive pathways within the electrode structure. In contrast to particulate or nanoscale conductive additives, the carbon fibers described herein are millimeter-scale fibers prior to dry mixing and are incorporated to form a load-bearing reinforcement network within the consolidated electrode sheet.

In the present disclosure, the initial average length of the carbon fibers is determined prior to introduction into the dry mixing apparatus. The initial fiber length refers to the average fiber length of the carbon fibers in their supplied state before dry mixing.

In certain embodiments, the carbon fibers have an average length of about 1 mm to about 20 mm prior to the dry mixing step. In alternative embodiments, the carbon fibers have an average length of about 1 mm to about 10 mm, alternatively about 3 mm to about 15 mm, alternatively about 5 mm to about 12 mm, and in particular embodiments about 5 mm to about 10 mm or about 8 mm to about 10 mm. In certain embodiments, the carbon fibers have an average length of at least about 5 mm prior to dry mixing. In other embodiments, the carbon fibers have an average length of at least about 8 mm prior to dry mixing.

As used herein, “average length” of the carbon fibers refers to a number-average fiber length determined from measurements of individual fibers or fiber segments. For carbon fibers prior to dry mixing, the fibers are millimeter-scale and the initial average length may be determined using macroscopic measurement techniques such as stereomicroscopy, optical imaging, calibrated digital photography, and/or calipers along the longest dimension of each fiber.

In some embodiments, the carbon fibers have an aspect ratio (length-to-diameter ratio) of at least about 50:1 prior to dry mixing, alternatively at least about 100:1. The carbon fibers may have an average diameter of about 3 μm to about 10 μm, alternatively about 4 μm to about 8 μm, and in particular embodiments about 5 μm.

The carbon fibers are not particularly limited and may comprise polyacrylonitrile (PAN)-based carbon fibers, pitch-based carbon fibers, rayon-based carbon fibers, or other carbonaceous fibers derived from suitable polymeric or petroleum-based precursors. In certain embodiments, the carbon fibers are high-strength or high-modulus carbon fibers commonly used in structural composite applications. The carbon fibers may be unsized, partially sized, or surface-treated prior to incorporation into the mixture.

As used herein, “unsized” refers to fibers that are substantially free of polymeric sizing agents applied during commercial fiber production. In other embodiments, the carbon fibers may include a sizing layer, coupling agent, oxidative surface treatment, plasma treatment, or other surface modification configured to enhance interfacial bonding with the polymer binder. Surface-treated fibers may include oxidized, functionalized, or coated fibers configured to improve dispersion or mechanical interlocking within the fibrillated binder matrix.

In contrast to conventional conductive carbon additives such as carbon black, carbon nanotubes, or vapor-grown carbon fibers, which typically possess micron-scale or sub-millimeter characteristic dimensions and function primarily as electronic percolation agents, the carbon fibers described herein are initially millimeter-scale reinforcement elements prior to dry mixing. The use of millimeter-scale fibers prior to shear processing provides a distinct structural advantage, as controlled fragmentation during mixing yields elongated fiber segments having sufficient aspect ratio to provide crack-bridging and load-transfer functionality in addition to electronic conduction. Thus, the carbon fibers described herein function not merely as conductive fillers, but as structural reinforcement elements integrated within the dry-processed electrode architecture.

During the dry mixing and subsequent processing, the carbon fibers may be mechanically fragmented into shorter fiber segments as a result of applied shear, compressive, and impact forces. In certain embodiments, the carbon fibers within the dry-processed battery electrode have an average length of about 20 μm to about 1 mm, alternatively about 50 μm to about 500 μm, and in particular embodiments about 80 μm to about 150 μm or about 100 μm. Despite such fragmentation, the fiber segments retain an aspect ratio sufficient to provide mechanical reinforcement and conductive bridging within the electrode matrix. The degree of fragmentation may be controlled through selection of mixing energy, mixing duration, and order of component addition.

For carbon fibers after dry mixing and consolidation, the fragmented fiber segments within the electrode may be measured by optical microscopy for larger fragments and by higher-resolution microscopy (e.g., SEM) for smaller fragments, depending on fragment size and the ability to distinguish the fragments from particulate conductive additives. In certain embodiments, electrode samples are imaged at multiple locations and/or fields of view, and fiber segment lengths are measured along the longest visible axis of each distinguishable segment using calibrated image analysis software. Where very small fragments cannot be reliably distinguished from particulate conductive carbon material, such fragments may be excluded from length measurements.

In certain embodiments, the fragmented carbon fibers cooperate with the fibrillated polymer binder network to form an interconnected composite reinforcement framework extending throughout the thickness of the electrode sheet. Without intending to be bound by theory, it is believed that the elongated fiber segments mechanically interlock with the fibrillated binder strands and bridge adjacent electrode active material particles, thereby distributing mechanical stress and inhibiting crack propagation within the consolidated structure. In certain embodiments, the carbon fiber network forms continuous or semi-continuous conductive pathways across the electrode thickness, contributing to reduced charge transfer resistance and improved electronic conductivity relative to comparable dry-processed electrodes lacking millimeter-scale carbon fibers prior to mixing.

In certain embodiments, the mixture comprises about 85 wt. % to about 95 wt. % electrode active material, about 1 wt. % to about 7 wt. % polymer binder, about 2 wt. % to about 6 wt. % conductive carbon material, and about 0.25 wt. % to about 2 wt. % carbon fibers, each based on the total weight of the mixture.

In certain embodiments, the mixture comprises about 88 wt. % to about 92 wt. % electrode active material, about 4 wt. % to about 6 wt. % polymer binder, about 3 wt. % to about 5 wt. % conductive carbon material, and about 0.8 wt. % to about 1.5 wt. % carbon fibers. In preferred embodiments, the mixture comprises about 90 wt. % electrode active material, about 5 wt. % polymer binder, about 4 wt. % conductive carbon material, and about 1 wt. % carbon fibers.

In some embodiments, the relative proportions of the components in the mixture are selected to provide sufficient mechanical integrity for formation of a free-standing electrode sheet upon compression while maintaining electronic percolation throughout the electrode structure. The amount of carbon fibers may be selected to provide internal reinforcement without substantially reducing active material loading.

In certain embodiments, providing the mixture comprises introducing the components of the mixture into the mixing vessel in a stepwise or sequential manner prior to or during the dry mixing step. In some embodiments, the polymer binder is introduced first, followed by the electrode active material, then the conductive carbon material, and finally the carbon fibers. Without being bound by any particular theory, it is believed that introducing the carbon fibers after at least partial mixing of the other components may reduce excessive fragmentation of the carbon fibers and promote formation of an internal reinforcement network within the electrode. However, the order of addition may be varied depending on the desired dispersion characteristics and equipment employed.

In some embodiments, providing the mixture comprises introducing the components into the mixing vessel substantially simultaneously, and dry mixing together without stepwise addition. In such embodiments, the electrode active material, conductive carbon material, polymer binder, and long carbon fibers may be combined prior to initiation of the dry mixing step and subjected to shear mixing as a single batch. The mixing parameters, including mixing frequency, duration, and mechanical energy input, may be selected to promote binder distribution and fibrillation while maintaining sufficient fiber length to provide internal reinforcement and conductive pathways. Simultaneous addition may be advantageous in certain processing configurations to simplify manufacturing operations, reduce processing time, or accommodate continuous or semi-continuous mixing systems. The selection between stepwise and simultaneous addition may be based on desired dispersion characteristics, fiber length retention, equipment configuration, and performance requirements.

The method includes dry mixing the mixture in the absence of liquid solvent and under shear conditions sufficient to distribute the electrode active material, conductive carbon material, polymer binder, and carbon fibers into a cohesive dry mixture.

As used herein, “dry mixing” refers to mixing performed without addition of a liquid solvent in an amount sufficient to dissolve or suspend the polymer binder.

In certain embodiments, the dry mixing is performed using a mechanical mixing apparatus capable of imparting shear, compressive, impact, and/or frictional forces to the mixture. Representative mixing devices include oscillatory mixer mills, planetary mixers, high-shear blade mixers, ribbon blenders, twin-screw mixers, attrition mixers, or combinations thereof. In some embodiments, the mixing vessel includes milling media, such as stainless steel balls, ceramic balls, or other grinding elements, configured to apply repeated compressive and shear forces to the mixture.

In particular embodiments, the dry mixing is performed using an oscillatory mixer mill operating at a frequency of about 10 Hz to about 50 Hz, alternatively about 20 Hz to about 40 Hz. In some embodiments, the mixing is conducted at approximately 30 Hz for one or more intervals of about 5 minutes to about 30 minutes per mixing stage. In certain embodiments, the total mixing time is about 10 minutes to about 60 minutes. The mixing parameters may be selected to promote binder fibrillation and homogeneous distribution of components while limiting excessive fragmentation of the carbon fibers.

In certain embodiments, the shear forces generated during dry mixing cause fibrillation of a fibrillatable binder, such as PTFE. Fibrillation results in formation of a fibrous binder network that interconnects the electrode active material, conductive carbon material, and carbon fibers. The mixture may assume a cohesive, agglomerated, fibrous, or dough-like texture indicative of binder fibrillation and interparticle entanglement.

In some embodiments, the shear forces applied during dry mixing mechanically fragment the carbon fibers from their initial average length prior to mixing into shorter fiber segments within the dry-processed electrode. In some embodiments, the fragmented carbon fibers have an average length of about 20 μm to about 1 mm, alternatively about 50 μm to about 500 μm, and in particular embodiments about 100 μm. Despite such fragmentation, the carbon fibers retain an aspect ratio sufficient to provide mechanical reinforcement and conductive bridging within the electrode matrix.

The shear energy input, mixing duration, and mixing frequency may be selected to achieve formation of a cohesive agglomerated mass while maintaining sufficient fiber length to provide mechanical reinforcement and extended conductive pathways within the resulting electrode sheet. In certain embodiments, the dry mixing step is performed in a batch process. In other embodiments, the dry mixing step is performed in a continuous or semi-continuous process suitable for large-scale electrode manufacturing.

In particular embodiments, the dry mixing is performed in a high-density polyethylene (HDPE) mixing vessel having a volume of about 30 mL to about 60 mL and containing milling media. In certain embodiments, the milling media comprise stainless steel balls having a diameter of about 5 mm to about 8 mm (for example approximately ¼ inch). In one embodiment, four stainless steel balls are used within a 40 mL mixing vessel. The components of the mixture may be introduced sequentially, with mixing performed after each addition step. In certain embodiments, the mixture is subjected to oscillatory mixing at approximately 30 Hz for about 10 minutes per addition step, resulting in a total mixing time of approximately 30 minutes. Such parameters have been found to promote binder fibrillation and homogeneous distribution of components while maintaining sufficient fiber length to form an internal reinforcement network within the dry-processed electrode.

The method includes compressing the mixture after dry mixing to form a free-standing electrode sheet. The compression step densifies the cohesive dry mixture and consolidates the fibrillated binder network and carbon fiber reinforcement framework to form a continuous film suitable for handling and subsequent battery assembly.

In certain embodiments, compressing the dry mixture comprises passing the dry mixture through a roll press. In other embodiments, compression may be achieved using calendaring rollers, flat-plate pressing, hot pressing, isostatic pressing, or other compression apparatus capable of applying pressure sufficient to consolidate the dry mixture into a coherent sheet. The compression step may be performed in a single pass or multiple passes to achieve a desired thickness and density.

In some embodiments, the compression apparatus includes one or more heated surfaces configured to apply both pressure and temperature to the dry mixture. In particular embodiments, a roll press is operated at a temperature of about 40° C. to about 150° C., alternatively about 60° C. to about 120° C., and in some embodiments approximately 80° C. The applied pressure may be about 1 MPa to about 200 MPa, alternatively about 5 MPa to about 100 MPa. The applied pressure and temperature may be selected to promote consolidation of the fibrillated binder network and mechanical interlocking of the carbon fibers without degrading the electrode active material.

In certain embodiments, the consolidated electrode sheet exhibits a bulk density of about 2.0 g/cm³ to about 4.5 g/cm³, alternatively about 2.5 g/cm³ to about 4.0 g/cm³. In some embodiments, the electrode sheet exhibits a porosity of about 10% to about 40%, alternatively about 15% to about 35%, alternatively about 20% to about 30%. The density and porosity may be selected to balance mechanical integrity, electronic conductivity, and ionic transport within the electrode.

In some embodiments, the compression step produces a mechanically self-supporting electrode sheet having sufficient mechanical integrity to be handled, transported, cut, slit, or punched without immediate support from a metallic current collector. In such embodiments, the free-standing electrode sheet has a thickness of about 30 μm to about 300 μm, alternatively about 50 μm to about 200 μm. In certain embodiments, the electrode sheet has a density sufficient to maintain structural cohesion while preserving ionic transport pathways within the electrode.

In certain embodiments, the compressed electrode sheet is subjected to calendaring to adjust thickness, density, porosity, and surface smoothness. Calendaring may be performed in one or more passes. In certain embodiments, calendaring is performed to achieve a desired areal capacity of about 3 mAh/cm² to about 7 mAh/cm², alternatively about 4 mAh/cm² to about 6 mAh/cm².

In some embodiments, the method further includes affixing the free-standing electrode sheet to a metallic current collector. Affixing the free-standing electrode sheet to a metallic current collector may comprise laminating the electrode sheet to the current collector using mechanical pressure, calendaring, roll pressing, hot pressing, or combinations thereof. In certain embodiments, affixing comprises passing the free-standing electrode sheet and the metallic current collector together through a roll press. The applied pressure and temperature may be selected to enhance bonding between the electrode sheet and the current collector without degrading the electrode active material or binder network.

The current collector is not particularly limited, as will be understood in view of the description below. In general, any current collector suitable for use in a lithium-ion battery can theoretically be utilized, with a particular current collector being selectable for use in view of the other battery components (i.e., the other electrode components, such as the binder and active materials thereof) by one of skill in the art. Examples of suitable current collectors generally include materials including aluminum, copper, nickel, titanium, stainless steel, and even some carbonaceous materials. Typically, the current collector is an aluminum foil. The current collector may be in any form known in the art, such as plates, sheets, foils, etc. Such terms may be overlapping in scope, as the current collector may have any thickness that is suitable for carrying a current, but will typically be selected with a minimal thickness in order to maximize energy density. Other materials and structures, as well as specific treatments (e.g. etching, coating, etc.) may be utilized to enhance the electrochemical stability and electrical conductivity of current collectors; however, it will be appreciated that not all composite current collectors may be suitable for use in the method in all circumstances, as the conditions and materials may be optimized for homogeneous metallic current collectors.

The current collector for cathode and anode electrodes will be independently selected. In certain embodiments, the lithium-ion battery includes a cathode having an aluminum current collector. In specific embodiments, the cathode current collector is an aluminum sheet or foil. In these or other embodiments, the lithium-ion battery includes an anode having a copper current conductor. In specific embodiments, the anode current collector is a copper sheet or foil.

In certain embodiments, the surface of the metallic current collector is modified prior to affixing to improve adhesion with the free-standing electrode sheet. Surface modification may include mechanical roughening, chemical treatment, plasma treatment, oxidation, coating, or application of a conductive interlayer.

In particular embodiments, the current collector is treated with a conductive interlayer. The conductive interlayer may comprise a mixture of a polymer binder and a conductive carbon material. In some embodiments, the interlayer comprises polyvinylidene fluoride (PVDF) and carbon nanotubes (CNT). In certain embodiments, the PVDF and CNT are combined in a weight ratio of about 5:95 to about 40:60, alternatively about 10:90 to about 30:70, and in particular embodiments about 15:85.

In some embodiments, the polymer binder and conductive carbon are dispersed in a solvent to form a coating slurry prior to application to the metallic current collector. In particular embodiments, the solvent comprises N-methyl-2-pyrrolidone (NMP) or another solvent suitable for dispersing the binder. The slurry may be mixed using mechanical agitation or shear mixing prior to coating.

The conductive interlayer may be coated onto the metallic current collector to a thickness of about 0.5 μm to about 20 μm, alternatively about 1 μm to about 10 μm, and in particular embodiments about 3 μm to about 5 μm. After drying of the interlayer coating, the free-standing electrode sheet may be affixed to the coated current collector using roll pressing or calendaring.

In certain embodiments, the method further includes calendaring the electrode after affixing the electrode sheet to the metallic current collector to further adjust thickness, density, and interfacial contact between the electrode sheet and the current collector. Calendaring may be performed in a single pass or multiple passes and may be conducted at ambient or elevated temperatures. In some embodiments, calendaring is performed at a pressure of about 1 MPa to about 200 MPa, alternatively about 5 MPa to about 100 MPa, and in particular embodiments about 10 MPa to about 50 MPa. The calendaring step may reduce interfacial voids, improve electrical contact between the electrode and current collector, and further densify the fibrillated binder-carbon fiber network.

The present disclosure further provides a dry-processed battery electrode comprising an electrochemically active material, a conductive phase, a polymeric binder phase, and elongated carbon fiber elements dispersed throughout the electrode structure. The components are consolidated into a cohesive sheet in the absence of solvent. In certain embodiments, the polymer binder is fibrillated or mechanically deformed to form a continuous or semi-continuous binder network interconnecting the active material and conductive components.

In certain embodiments, the dry-processed battery electrode comprises about 80 wt. % to about 97 wt. % electrode active material, about 1 wt. % to about 10 wt. % conductive carbon material, about 1 wt. % to about 10 wt. % polymer binder, and about 0.25 wt. % to about 2 wt. % carbon fibers, each based on total electrode weight. In particular embodiments, the electrode comprises about 90 wt. % active material, about 5 wt. % binder, about 4 wt. % conductive carbon material, and about 1 wt. % carbon fibers.

In some embodiments, the carbon fibers within the dry-processed battery electrode have an average length of about 20 μm to about 1 mm after consolidation, alternatively about 20 μm to about 500 μm, and in particular embodiments at least about 100 μm. Despite fragmentation from their initial millimeter-scale length prior to dry mixing, the carbon fibers retain an aspect ratio sufficient to provide mechanical reinforcement, crack-bridging functionality, and conductive bridging within the electrode matrix.

In certain embodiments, the carbon fibers are distributed substantially through the thickness of the electrode sheet and form a three-dimensional reinforcement and conductive network. The fiber network may form continuous or semi-continuous pathways between regions of electrochemically active material, thereby enhancing electronic percolation and mechanical load distribution within the electrode.

The dry-processed battery electrode may be configured as a mechanically self-supporting film capable of being handled, cut, slit, punched, wound, stacked, or transferred without support from a metallic current collector. In certain embodiments, the electrode sheet exhibits sufficient tensile strength and flexural rigidity to maintain structural integrity during automated cell assembly operations.

In other embodiments, the dry-processed battery electrode further comprises a metallic current collector affixed to the electrode sheet. The metallic current collector may comprise aluminum, copper, stainless steel, nickel, titanium, or other electrically conductive substrates suitable for electrochemical energy storage devices.

In certain embodiments, the carbon fiber-binder composite architecture increases tensile strength, flexural resistance, and fracture toughness of the electrode relative to comparable dry-processed electrodes lacking elongated carbon fibers. In some embodiments, the electrode exhibits a tensile strength of at least about 400 kPa, alternatively at least about 450 kPa, alternatively at least about 500 kPa.

In some embodiments, the composite architecture formed by the binder network and carbon fiber reinforcement enhances electronic transport properties. The interconnected fiber-binder framework may provide extended conductive pathways across the electrode thickness, thereby reducing electronic resistance and improving charge transport efficiency.

In certain embodiments, incorporation of elongated carbon fibers improves thermal transport within the electrode by providing high-conductivity pathways that facilitate heat dissipation during operation. Thermal conductivity may be increased relative to comparable dry-processed electrodes lacking elongated fibers.

In some embodiments, the reinforcement and conductive network reduces interfacial impedance and charge transfer resistance within the electrode. The reduction in internal resistance may improve rate capability, cycle stability, and overall electrochemical durability.

The dry-processed electrodes described herein are compatible with cell assembly practices known in the art and may be used in half-cells, full-cells, and multi-cell battery modules. Representative cell formats include coin cells (e.g., CR2032), pouch cells, cylindrical cells (e.g., 18650, 21700), and prismatic cells. A typical cell includes a counter electrode or anode, the dry-processed cathode or anode described herein, a porous separator (for example polyethylene, polypropylene, or coated separators), and a liquid, gel, or solid electrolyte comprising suitable salts (e.g., LiPF₆, LiFSI, LiTFSI) and solvent systems (e.g., EC/EMC, EC/DMC) or solid polymer/ceramic electrolytes. The present electrodes may be used with conventional formation cycling, electrolyte filling, and cell finishing operations.

In certain embodiments, the electrode active material comprises a cathode active material. In other embodiments, the electrode active material comprises an anode active material. The structural reinforcement and conductive network benefits described herein are applicable to either electrode configuration.

In some embodiments, the dry-processed battery electrode is fabricated at an areal loading of at least about 3 mAh/cm², alternatively at least about 4 mAh/cm², alternatively at least about 5 mAh/cm², and in particular embodiments about 4 mAh/cm² to about 7 mAh/cm². In some embodiments, the electrode is fabricated at an areal loading of about 4.5 mAh/cm² to about 6 mAh/cm². The areal loading may be selected based on desired energy density and application requirements.

In certain embodiments, the ability to fabricate the electrode at higher areal loadings while maintaining mechanical integrity and electronic percolation is enabled by the internal reinforcement network formed by the elongated carbon fibers. Without intending to be bound by theory, it is believed that the carbon fiber-binder composite framework provides structural support that mitigates cracking, delamination, and cohesion loss that may otherwise occur in high-loading dry-processed electrodes.

In certain embodiments, the electrode fabricated at an areal loading of at least about 4 mAh/cm² exhibits a thickness of about 50 μm to about 200 μm and maintains sufficient tensile strength to function as a free-standing film. In some embodiments, the electrode density and porosity are selected to balance ionic transport and electronic conductivity at elevated loadings.

In some embodiments, the dry-processed battery electrode exhibits an initial discharge capacity of at least about 175 mAh/g, alternatively at least about 180 mAh/g, and in particular embodiments about 184 mAh/g during formation cycles. In certain embodiments, the electrode exhibits a discharge capacity after 50 cycles of at least about 125 mAh/g, alternatively at least about 150 mAh/g. In some embodiments, the electrode maintains measurable discharge capacity at rates of at least 1 C, and in particular embodiments delivers at least about 40 mAh/g at 1 C.

In certain embodiments, the reduction in charge transfer resistance is observed in equivalent circuit modeling of electrochemical impedance spectroscopy, wherein the Rct component is reduced by at least about 30%, alternatively by more than about 50%, relative to a comparable electrode lacking elongated carbon fibers.

### EXAMPLES

The present method is further described in connection with the following laboratory examples, which are intended to be non-limiting.

The specific materials, component sources, equipment models, and test conditions described in the foregoing Example are provided for illustrative purposes only. The invention is not limited to the particular grades, suppliers, or commercial designations identified herein. Any commercially available electrode active materials, polymer binders, conductive carbon materials, carbon fibers, current collectors, separators, electrolytes, mixing equipment, or consolidation equipment that provide substantially similar functionality may be used. One of ordinary skill in the art will recognize that equivalent materials and processing conditions may be substituted without departing from the scope of the present invention.

### Preparation Example 1: Preparation of Dry-Processed Cathode/Electrode Sheets

A dry-processed cathode electrode sheet was fabricated from a substantially solvent-free powder mixture comprising LiNi_{0·8}Mn_{0·1}Co_{0·1}O₂ (NMC811), polytetrafluoroethylene (PTFE), carbon black, and long carbon fibers. The mixture comprised approximately 90 wt. % LiNi_{0·8}Mn_{0·1}Co_{0·1}O₂ (NMC811, Targray), 5 wt. % PTFE binder (601 X, Chemours), 4 wt. % carbon black (Denka), and 1 wt. % carbon fiber (HexTow® IM7, Hexcel), based on the total weight of the mixture. The carbon fibers had an initial average length of approximately 8-10 mm prior to dry mixing.

The materials were introduced sequentially into a 40 mL high-density polyethylene (HDPE) mixing vessel containing four ¼-inch stainless-steel balls. The PTFE binder was introduced first, followed by the NMC811 active material, then carbon black, and finally the carbon fibers. After each addition, the mixture was processed in a Retsch MM400 mixer mill at 30 Hz for 10 minutes, resulting in a total mixing time of 30 minutes.

The resulting powder mixtures were fabricated into cathode electrode films using a roll press machine having temperature-controlled roller at 80° C. to produce thin electrode sheets.

The thin electrode sheets were affixed to aluminum foil current collectors. The PTFE-containing electrode sheets exhibited limited adhesion to untreated aluminum surfaces. To improve adhesion, a conductive interlayer was prepared by mixing polyvinylidene fluoride (PVDF) and carbon nanotubes (CNT) at a 15:85 weight ratio in N-methyl-2-pyrrolidone (NMP) solvent at approximately 30 Hz for 10 minutes. The slurry was coated onto the aluminum foil to a thickness of approximately 3-5μm and dried. The dry-processed electrode sheets were affixed onto the coated aluminum foil using a roll press.

### Comparative Example 1: Preparation of Comparative Cathode/Electrode Sheets

Comparative electrode films were prepared using the same procedure as Preparation Example 1, except that no carbon fibers were included in the dry mixture. The initial mixture comprised a 90:5:5 weight ratio of NMC 811, PTFE binder, and carbon black.

### Preparation Example 2: Anode Electrodes

The anode electrodes were prepared in conventional wet processing for full cell tests. 92 wt. % graphite (Superior SLC 1520 T), 6 wt. % PVDF (Kureha 9300), and 2 wt. % CB (Imerys C-NERGY C65) were thoroughly mixed in N-methyl-2-pyrrolidone (NMP) at 30 Hz for 45 min. The resulting slurry was coated onto a copper foil using a doctor blade. The graphite anode mass loading was selected to balance the dry-processed cathode such that the anode-to-cathode capacity ratio (N/P ratio) was approximately 1.1 relative to the dry-processed cathode having an areal capacity of approximately 5.2 mAh/cm².

### Preparation Example 3: Battery Cell

The dry-processed cathode electrodes prepared according to Preparation Example 1 and Comparative Preparation Example 1 were punched into desired sizes and assembled into CR 2032-type coin cells using either the graphite anode of Preparation Example 2 or lithium metal as the counter electrode. A porous separator (Celgard 2325) and approximately 100 μL of electrolyte comprising 1.2 M LiPF₆ in ethylene carbonate (EC) and ethyl methyl carbonate (EMC) (3: 7 weight ratio) were used.

### Material Characterizations

The electrode sheets prepared according to Preparation Example 1 were characterized using ESCALAB Xi+SEM (Thermo Scientific) and VHX-7000 optical microscopy (Keyence). The electrode films were subjected to mechanical strength tests. Tensile tests were performed using a tensile frame (MTS Systems). Adhesion strengths were measured by a friction peel tester (Mecmesin). Electronic conductivity of the dry-processed electrodes was measured by four-point probe (Ossila). Thermal conductivities were obtained using TPS 2500 S (Hot Disk).

### Electrode Performance Testing

Electrochemical testing was performed on battery cells prepared according to Example 3 using a battery cycler (e.g., Maccor Series 4000). Formation cycles included constant current charging at 0.05 C followed by constant voltage charging to 4.2 V and discharge at 0.05 C between 3.0 V and 4.2 V. Subsequent cycle life testing was conducted at 0.1 C within a voltage window of 3.0-4.2 V. Rate capability testing included constant voltage charging to 4.2 V followed by constant current discharge at progressively increasing C-rates ranging from approximately 0.2 C to 5.0 C, with recovery cycles performed at 0.1 C. Electrochemical impedance spectroscopy (EIS) measurements were conducted using a potentiostat over a frequency range of 1 MHz to 100 mHz with a 5 mV AC perturbation.

### Differential Scanning Calorimetry (DSC)

Differential scanning calorimetry (DSC) was performed on electrode films prepared with and without long carbon fibers. Films were controlled to approximately 100 μm thickness. A heat-cool-heat protocol with a ramp rate of approximately 5° C. per minute was applied. The thermal cycle included heating from approximately 30° C. to approximately 150° C., cooling to approximately 50° C., and final heating to approximately 400° C.

### Results

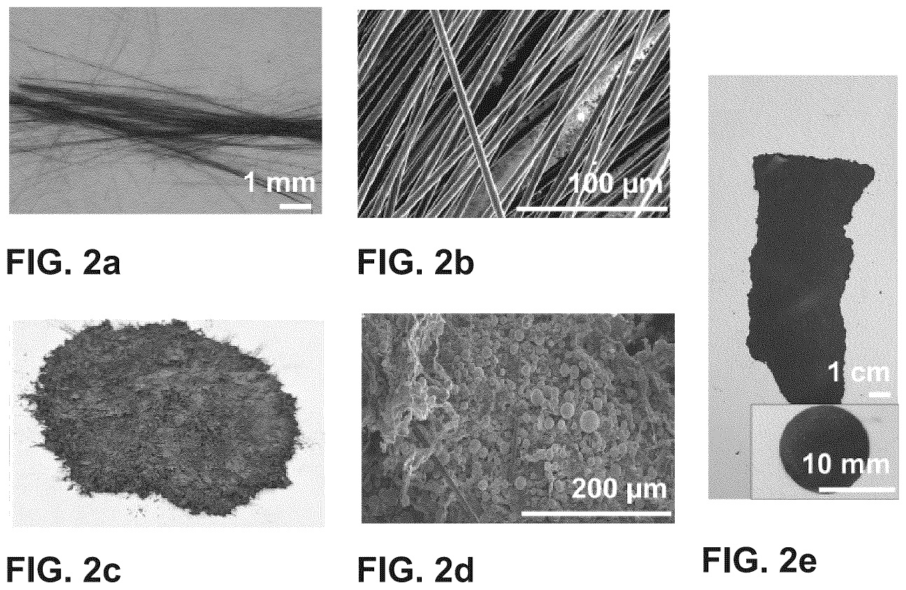

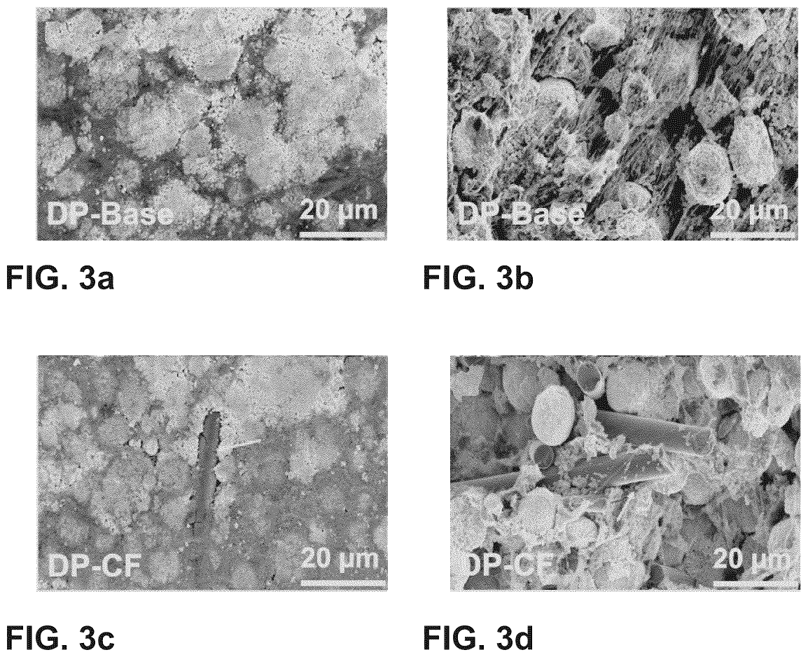

SEM analysis confirmed dispersion of carbon fibers throughout the electrode and formation of a fibrillated binder network, as shown in FIGS. 2a-2e and FIGS. 3a-3d. As illustrated in FIGS. 2 a-2e, the carbon fibers initially exhibited lengths of approximately 8-10 mm prior to mixing and were fragmented during dry processing to average lengths of approximately 100 μm within the electrode film. Cross-sectional SEM images in FIGS. 3a-3d demonstrate that the fragmented fibers retained an elongated cylindrical morphology and were embedded within the fibrillated binder matrix extending through the electrode thickness.

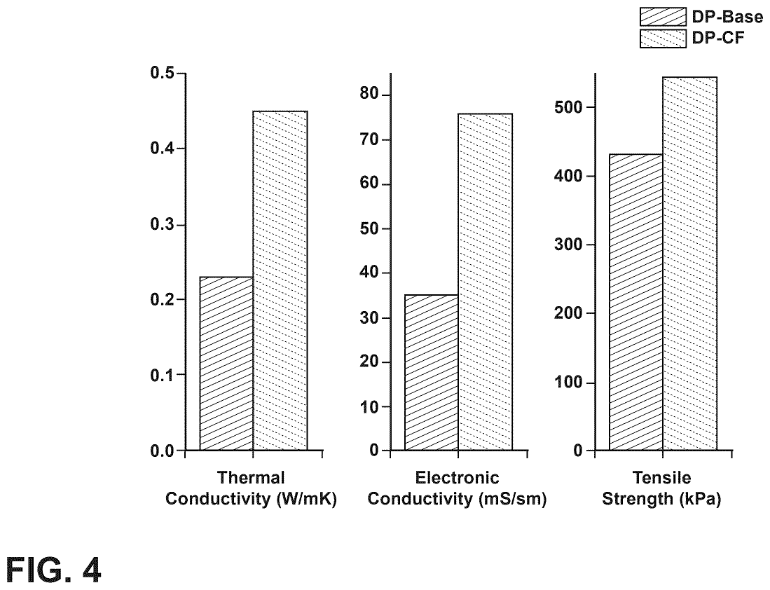

As shown in FIG. 4, incorporation of approximately 1 wt. % carbon fiber resulted in substantial increases in measured physical properties relative to the baseline electrode lacking carbon fibers. Thermal conductivity increased from approximately 0.23 W/m·K to approximately 0.45 W/m·K, representing an increase of nearly 100%. Electronic conductivity increased from approximately 35 mS/cm to approximately 76 mS/cm, representing an increase of more than 100%. Tensile strength increased from approximately 431 kPa to approximately 545 kPa, corresponding to an increase of approximately 26%. These improvements were achieved at comparable electrode loading and thickness.

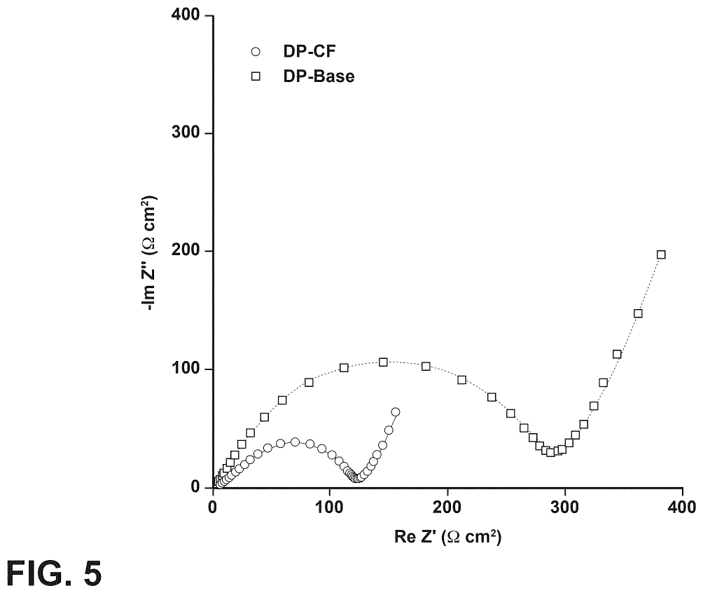

Nyquist plots shown in FIG. 5 demonstrate that incorporation of carbon fibers substantially reduced charge transfer resistance (Rct). The baseline electrode exhibited a charge transfer resistance of approximately 233Ω, whereas the carbon fiber-reinforced electrode exhibited a charge transfer resistance of approximately 87Ω, corresponding to a reduction of approximately 60%. This reduction in interfacial impedance is consistent with the observed increase in bulk electronic conductivity shown in FIG. 4.

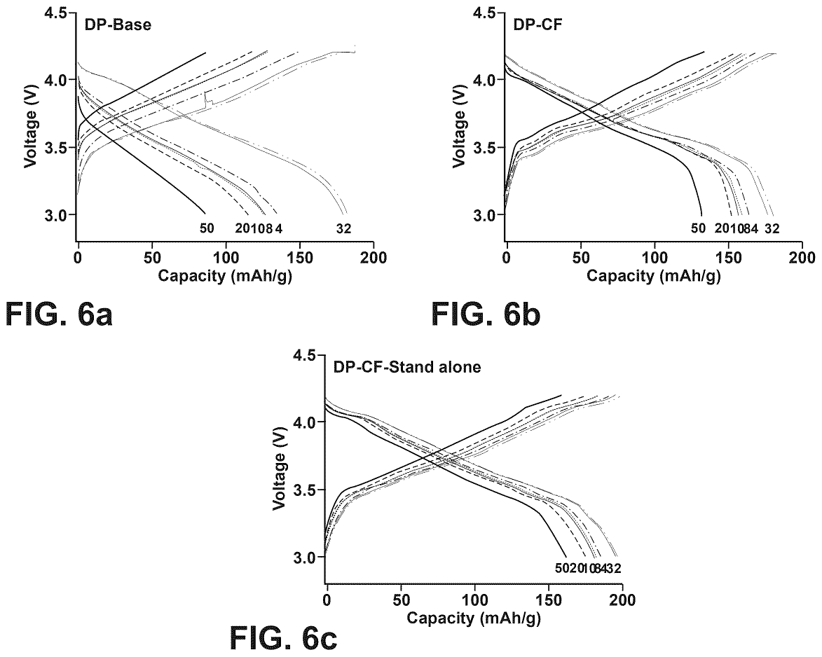

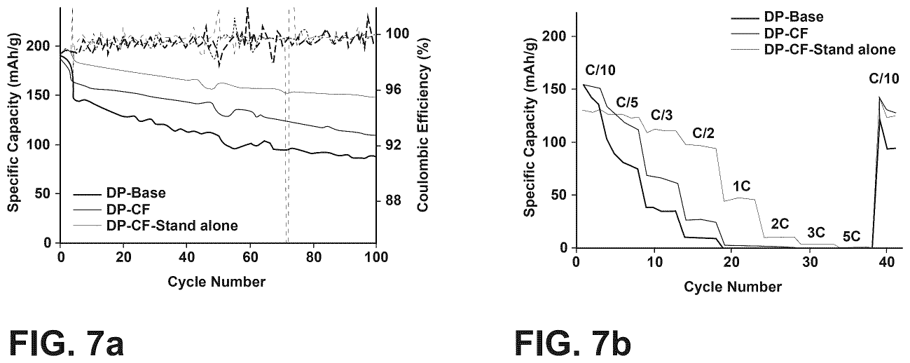

Representative voltage profiles are shown in FIGS. 6a-6c, and long-term cycling and rate capability results are shown in FIGS. 7a-7b. After 50 cycles at C/10, the baseline electrode retained approximately 64.4% of its initial capacity, whereas the carbon fiber-reinforced electrode retained approximately 80.9%, representing an improvement of approximately 16 percentage points in capacity retention. The standalone carbon fiber-reinforced configuration retained approximately 84.3% capacity after 50 cycles, representing an improvement of approximately 20 percentage points relative to the baseline electrode. The standalone configuration also demonstrated higher absolute discharge capacities during cycling.

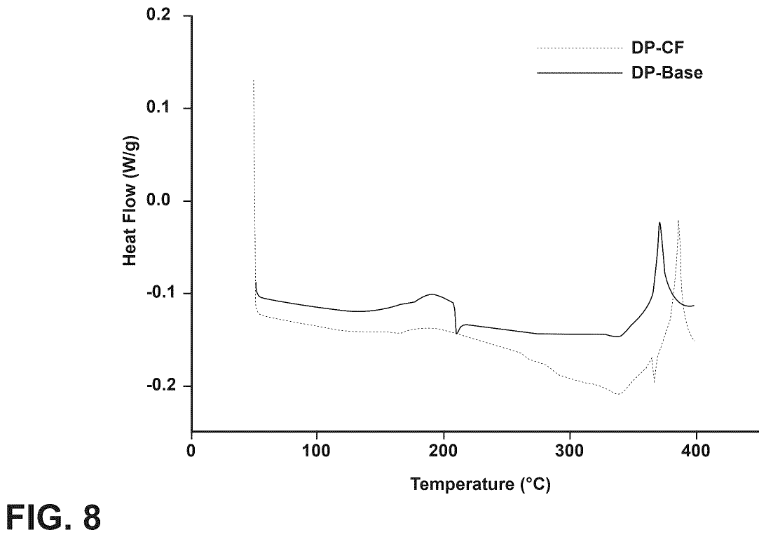

Differential scanning calorimetry (DSC) results shown in FIG. 8 further indicate enhanced thermal behavior in the carbon fiber-reinforced electrode. The baseline electrode exhibited a heat flow peak at approximately 210° C. that was not observed in the carbon fiber-containing electrode. Additionally, the phase transition peak associated with the NMC material shifted from approximately 360° C. in the baseline electrode to approximately 380° C. in the carbon fiber-reinforced electrode, indicating improved thermal stability.

### Summary of Experimental Findings

Collectively, the experimental examples demonstrate that while dry-processed cathode electrodes lacking long carbon fibers exhibit measurable electronic conductivity, thermal conductivity, mechanical strength, and electrochemical performance, compositions comprising long carbon fibers incorporated into the dry-processed electrode matrix provide enhanced physical and electrochemical performance relative to electrodes without carbon fibers.

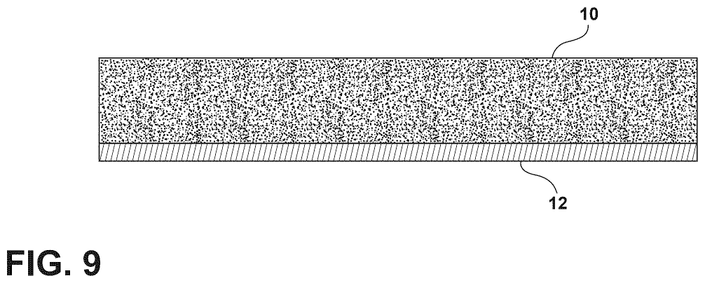

The examples described above provide experimental evidence supporting a synergistic structural and conductive interaction between the long carbon fibers and the fibrillated polymer-bound electrode matrix. In particular, the comparative and experimental examples demonstrate that while the baseline dry-processed electrode exhibits defined levels of conductivity, tensile strength, and cycling performance, incorporation of long carbon fibers into the electrode composition in defined proportions provides enhanced electronic conductivity, enhanced thermal conductivity, reduced charge transfer resistance, improved capacity retention, and improved rate capability relative to the baseline electrode alone. The resulting battery electrode includes an electrochemically active material, a conductive carbon material to provide electronic conductivity, a fibrillated polymer binder that mechanically binds the components together, and carbon fibers dispersed throughout the electrode structure. In some embodiments, the dry-processed electrode is a self-supporting film, meaning it maintains structural integrity without being attached to a metallic current collector. In other embodiments, the dry-processed electrode 10 is affixed to a metallic current collector 12, as shown in FIG. 9 for example.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of manufacturing a dry-processed battery electrode, the method comprising:
providing a mixture comprising an electrode active material, a conductive carbon material, a polymer binder, and carbon fibers;
dry mixing the mixture in the absence of solvent and under shear conditions; and
compressing the dry mixture into a free-standing electrode sheet;
wherein the carbon fibers have an average length of at least 5 mm prior to the dry mixing.

2. The method of claim 1, wherein the carbon fibers have an average length of at least 8 mm prior to the dry mixing.

3. The method of claim 1, wherein the carbon fibers have an average length of about 8 mm to about 10 mm prior to the dry mixing.

4. The method of claim 1, wherein the carbon fibers have an average diameter of about 3 μm to about 10 μm prior to the dry mixing.

5. The method of claim 1, wherein the carbon fibers have an average diameter of about 5 μm prior to the dry mixing.

6. The method of claim 1, wherein the carbon fibers are present in an amount of about 0.25 wt. % to about 2 wt. % based on the total weight of the dry mixture.

7. The method of claim 1, wherein the carbon fibers are present in an amount of about 1 wt. % based on the total weight of the dry mixture.

8. The method of claim 1, wherein the dry mixture comprises:
about 85 wt. % to about 95 wt. % of the electrode active material;
about 1 wt. % to about 7 wt. % of the polymer binder;
about 2 wt. % to about 6 wt. % of the conductive carbon material; and
about 0.25 wt. % to about 2 wt. % of the carbon fibers,
each based on the total weight of the dry mixture.

9. The method of claim 8, wherein the dry mixture comprises:
about 90 wt. % of the electrode active material;
about 5 wt. % of the polymer binder;
about 4 wt. % of the conductive carbon material; and
about 1 wt. % of the carbon fibers,
each based on the total weight of the dry mixture.

10. The method of claim 1, wherein
the electrode active material comprises one or more of lithium nickel manganese cobalt oxide (NMC), lithium nickel cobalt aluminum oxide (NCA), lithium iron phosphate (LFP), lithium manganese oxide (LMO), and lithium cobalt oxide (LCO);
the conductive carbon material comprises one or more of carbon black, carbon nanotubes, graphene, graphite, and vapor-grown carbon fibers; and
the polymer binder comprises one or more of polytetrafluoroethylene (PTFE), polyvinylidene fluoride (PVDF), polyethylene oxide (PEO), and styrene-butadiene rubber (SBR).

11. The method of claim 1, wherein the carbon fibers in the dry-processed battery electrode have an average length of about 50 μm to about 1 mm.

12. The method of claim 11, wherein the carbon fibers in the dry-processed battery electrode have an average length of about 100 μm.

13. The method of claim 1, wherein the dry mixing further comprises sequentially mixing the polymer binder, then the electrode active material, then the conductive carbon material, and then the carbon fibers.

14. The method of claim 1, wherein forming the free-standing electrode sheet comprises roll pressing the dry mixture using a heated roller.

15. The method of claim 1, further comprising affixing the free-standing electrode sheet to a metallic current collector.

16. The method of claim 1, wherein the dry mixing causes fibrillation of the polymer binder.

17. A dry-processed battery electrode comprising:
an electrode active material;
a conductive carbon material;
a fibrillated polymer binder; and
carbon fibers dispersed throughout the electrode,
wherein the carbon fibers have an average length of about 20 μm to about 150 μm.

18. The dry-processed battery electrode of claim 17, wherein the carbon fibers have an average length of at least about 100 μm.

19. The dry-processed battery electrode of claim 17, wherein the electrode is a self-supporting film not affixed to a metallic current collector.

20. The dry-processed battery electrode of claim 17, further comprising a metallic current collector affixed to the electrode.
